(19) United States
(12) Patent Application Publication
(10) Pub. No.: US 2026/0271973 A1
(43) Pub. Date: Sep. 17, 2026

(54) electromagnetic heating popcorn machine with spherical pot body

(71) Applicant: XDF(HONGKONG) MACHINERY TECHNOLOGY LIMITED, Hong Kong (CN)

(72) Inventor: Chen Feihua, Xiamen City (CN)

(21) Appl. No.: 19/077,354

(22) Filed: Mar. 12, 2025

(51) Int. Cl. A23L 7/187; A47J 27/00; A47J 36/16; B01F 27/091; B01F 27/17; B01F 27/71; B01F 35/32; B01F 35/33; B01F 35/90; B01F 35/94; B01F 101/06; H05B 6/12

(52) U.S. Cl. CPC A23L 7/187; A47J 27/004; A47J 36/165; B01F 27/091; B01F 27/17; B01F 27/71; B01F 35/3204; B01F 35/3214; B01F 35/33; B01F 35/94; H05B 6/12; B01F 2035/99; B01F 2101/06

(57) ABSTRACT

An electromagnetic heating popcorn machine is provided. Which includes an electromagnetic base, a spherical pot body provided on the electromagnetic base, and a stirring structure configured to stir popcorn inside the spherical pot body; the mixing structure includes a bracket fixedly provided on the spherical pot body, a T-shaped sleeve inserted on the bracket and extending into the spherical pot body, a first rotation rod inserted horizontally at a bottom of the T-shaped sleeve, fixed sleeves symmetrically fixed on two sides of the first rotation rod, a plurality of stirring plates that are arranged in a circular array and fixedly connected to the fixed sleeves, and a driving component configured to drive the first rotation rod to rotate, electromagnetic heating renders the heating speed faster, shortens the heating time, and improves the efficiency of popcorn processing. A horizontal stirring way allows the popcorn to be heated more evenly.

### TECHNICAL FIELD

The present disclosure relates to the field of food machinery technologies, and in particular, to an electromagnetic heating popcorn machine with a spherical pot body.

### BACKGROUND

Popcorn, as a popular snack, has been continuously improved in its production technology to meet market demand.

The ordinary popcorn equipment is to add a heating tube to the bottom of a stainless steel pan. After the heating tube is powered on, the pot body is heated to 180° C. (the puffing temperature of corn) and begins to pop popcorn. This heating way takes at least 3 minutes to heat up to 180° C., and 5-7 minutes to pop a pot of popcorn, which is a waste of time and has low production efficiency.

Heating regular popcorn to the puffing temperature of corn takes at least 3 minutes, and the process is relatively slow, which renders the puffing effect not very good. The size of the popped popcorn particles is limited, which to some extent affects the final taste of the popcorn.

During the heating process of the regular pan popcorn machine, there will be a stirrer constantly stirring. Due to the centrifugal force during the stirring process, the corn and seasoning sugar in the pot will be distributed and scattered around the pot wall. The effective heating area of the pot body is in the center of the pot body rather than the edge of the pot, so this will result in a relatively low yield of popcorn, usually only reaching 85%-90% (the actual expansion rate of the finished product is determined by the quality of the corn).

The popcorn in the regular pan is relatively shallow. The popcorn that bursts first will stay above the corn and other ingredients, and when it reaches a certain amount, it will pop out of the pot first by opening the lid. However, the seasoning sugar is basically kept at the bottom of the pot, which renders it difficult for the popcorn that bursts first to wrap in the seasoning sugar. Therefore, as for the whole pot, the taste will be uneven, some will be wrapped with sugar, some will not be wrapped with sugar, and the taste will be uneven.

Furthermore, this heating way by heating tube has low heat conversion efficiency and high energy consumption. After turned off, the heating tube still has a relatively high residual temperature, rendering it difficult to cool down. If the pot is washed after being turned off, it needs a long time.

Firstly, due to the traditional stirring structure rotating along the axis of the pot, in the popcorn machine, first popped popcorn that is light and the corn that has not yet popped often float above the corn and other ingredients in the popcorn machine. And the sugar used for seasoning is basically kept near a bottom of the pot. Due to the uneven spatial distribution, the popcorn that popped first is difficult to wrap with seasoning sugar, resulting in differences in the taste of the entire pot of popcorn. Some popcorn is fully coated with sugar and has a sweet and fragrant taste, but some have almost no sugar coating, with a bland taste. The problem of uneven taste seriously affects consumers'consumption experience.

Therefore, the present disclosure provides an electromagnetic heating popcorn machine with a spherical pot body to solve the above-mentioned problems.

### SUMMARY

The present disclosure provides an electromagnetic heating popcorn machine with a spherical pot body, aiming to solve the existing problem in the background technology that due to the traditional stirring structure rotating along the axis of the pot body, first popped popcorn that is light and the corn that has not yet popped often float above the corn and other ingredients in the popcorn machine. And the sugar used for seasoning is basically kept near a bottom of the pot. Due to the uneven spatial distribution, the popcorn that popped first is difficult to wrap with seasoning sugar, resulting in differences in the taste of the entire pot of popcorn. Some popcorn is fully coated with sugar and has a sweet and fragrant taste, but some have almost no sugar coating, with a bland taste. The problem of uneven taste seriously affects consumers'consumption experience and other issues.

To achieve the above objectives, the present disclosure provides the following technical solution: an electromagnetic heating popcorn machine with a spherical pot body, including a electromagnetic base, a spherical pot body provided on the electromagnetic base, an induction cooker fixedly provided on the electromagnetic base and adapted to a bottom of the spherical pot body, and a stirring structure configured to stir popcorn inside the spherical pot body;
different from the existing popcorn machine, the spherical pot body is heated by a cooperation of the electromagnetic base and the induction cooker; the use of electromagnetic heating can shorten the heating time for the spherical pot body and improve the processing efficiency of popcorn, this electromagnetic heating technology heats the pot body directly, reducing energy transfer losses and significantly improving thermal efficiency; compared to traditional resistance heating or gas heating ways, electromagnetic heating has a higher thermal efficiency, usually reaching over 98%, thereby achieving higher energy utilization and lower energy consumption; this high-efficiency and energy-saving feature enables the electromagnetic heating pot body to significantly reduce energy consumption and lower operating costs during long-term use;
by using electromagnetic heating, the heating power can be automatically adjusted according to a set temperature, ensuring the temperature stability of popcorn during processing; accurate temperature control can avoid the problem of unstable quality of popcorn caused by temperature fluctuations, ensuring the consistency of the product; the electromagnetic heating process does not produce harmful substances, does not pollute the environment, and conforms to the concept of green environmental protection; compared to gas heating ways, electromagnetic heating reduces exhaust emissions and noise pollution, which is beneficial for protecting the environment and improving the working environment in the kitchen;
by using electromagnetic heating, the pot body will exhibit heating characteristics such as rapid heating, uniform heating, and temperature controllability after heating, and has advantages such as high efficiency, energy saving, environmental friendliness, high safety performance, easy cleaning and maintenance, and multifunctionality;
the stirring structure includes a bracket fixedly provided on the spherical pot body, a T-shaped sleeve inserted on the bracket and extending into the spherical pot body, a first rotation rod inserted horizontally at a bottom of the T-shaped sleeve, fixed sleeves symmetrically fixed on two sides of the first rotation rod, a plurality of stirring plates that are arranged in a circular array and fixedly connected to the fixed sleeves, and a driving component configured to drive the first rotation rod to rotate; the driving component includes a first bevel gear fixedly sleeved on the first rotation rod, a second rotation rod vertically and rotatably inserted into the T-shaped sleeve, a second bevel gear fixedly sleeved on a bottom of the second rotation rod and engaged with the first bevel gear, and a driving motor fixedly provided on the bracket; an output end of the driving motor is fixedly connected to an upper of the second rotation rod. When in use, the induction cooker first started to heat the spherical pot body. Then, the first rotation rod is driven to rotate by the driving component. The first rotation rod drives the popcorn and additives inside the spherical pot body to flip back and forth through the fixed sleeves and stirring plates. This flipping not only evenly heats the popcorn, but also thoroughly mixes it with additives. When the popcorn reaches the desired texture and taste, the induction cooker is turned off and the operation of the driving component is stopped. At this point, due to the stirring effect of the stirring structure, popcorn can be quickly removed from the spherical pot body for consumers to enjoy. When cleaning, a small amount of water is added and the stirring structure is stared to heat for one minute, and water droplets formed by water evaporation can be used to automatically clean an inside of the spherical pot body.

In some embodiments of the present disclosure, in order to reduce a squeezing of popcorn by the stirring plates: the stirring plates are arc-shaped plates, curvatures of the stirring plates are arranged along a rotation direction of the first rotation rod. The arc-shaped stirring plates design allows for a gentle pushing effect on the popcorn on a stirring path during rotation, rather than traditional direct impact or compression. This gentle pushing effect not only effectively reduces a mutual squeezing between popcorn, but also lowers a breakage rate of popcorn, thereby improving the overall quality of popcorn.

In some embodiments of the present disclosure, in order to maintain one end of each of the stirring plates in contact with an inner wall of the pot body; one end of each of the stirring plates far away from the fixed sleeves is slidably inserted with a telescopic plate; one end of the telescopic plate far away from the stirring plates is fixedly connected with a first scraper that abuts against an inner wall of the spherical pot body; a limit groove is provided inside the stirring plates, and a limit plate fixedly connected to the telescopic plate is provided inside the limit groove; one end of the limit groove and one end of the telescopic plate that are away from the telescopic plate are provided with springs. By a close contact between the scraper and the inner wall of the spherical pot body, during the mixing process, the first scraper can not only ensure a contact between the stirring plates and the inner wall of the pot body, but also effectively scrape off the additives adhered to the pot body, thereby improving a mixing effect of the additives and popcorn.

In some embodiments of the present disclosure, in order to facilitate the stirring plates to drive the popcorn and additives located inside the spherical pot body to flip upwards during rotation: the first scraper is a L-shaped plate, a L-end of the first scraper is arranged along the rotation direction of the first rotation rod. The L-shaped first scraper design fully utilizes the kinetic energy generated by the stirring plates during rotation. When the stirring plates are rotated, the L-end of the first scraper will slide along the bottom of the pot body, and due to its special shape and orientation, it can effectively flip the popcorn and additives located at the bottom of the spherical pot body upwards.

In some embodiments of the present disclosure, in order to facilitate a circumferential rotation of the stirring structure around the second rotation rod; a driving structure configured to drive the T-shaped sleeve to rotate in the circumferential direction is provided on the bracket; the driving structure includes a transmission gear fixedly sleeved on the second rotation rod, a plurality of driven gears that are arranged in a circular array, engaged on the transmission gear and rotatably connected to the bracket; and an internal gear ring sleeved on the driven gears and fixedly connected to an upper of the T-shaped sleeve. By implementing a revolution of the stirring structure, dead corners of stirring are further reduced, allowing popcorn and additives to mix more thoroughly and improving the overall quality.

In some embodiments of the present disclosure, in order to facilitate the mixing of popcorn and additives located between two fixed sleeves at the bottom of the pot body: a bottom of the T-shaped sleeve is fixedly connected to a third rotation rod, and a bottom of the third rotation rod is fixedly sleeved with a second scraper that abuts against an inner wall of the spherical pot body; a stirring blade is fixedly sleeved on the third rotation rod. By adding the third rotation rod, the second scraper, and the stirring blade, the popcorn and additives located between the two fixed sleeves can be fully stirred and mixed, thereby improving the overall quality.

In some embodiments of the present disclosure, in order to prevent popcorn from being removed from the spherical pot body during processing: the T-shaped sleeve is sleeved with a protective cover that abuts against an upper of the spherical pot body; the protective cover is provided with a plurality of ventilation holes; for a convenience of adding popcorn and additives to the spherical pot body, two ends of the protective cover are symmetrically and fixedly connected to fixed rods; the bracket is provided with vertical grooves for the fixed rods to move up and down; an electric push rod is fixedly provided inside the bracket; an output end of the electric push rod is fixedly connected to bottoms of the fixed rods. The design of the protective cover effectively prevents splashing during popcorn processing, ensuring the safety of an operator and the cleanliness of the environment.

In some embodiments of the present disclosure, in order to facilitate the pouring of popcorn from the pot body; a support rod is fixedly inserted on the bracket; two ends of the support rod are sleeved with bearing seats that are fixedly connected to the electromagnetic base; a hydraulic cylinder is rotatably provided on the electromagnetic base; an output end of the hydraulic cylinder is connected to the bracket. The introduction of the hydraulic cylinder renders the tilting of spherical pot body easy and efficient, and the operator can easily pour out popcorn without any effort, greatly improving the convenience of operation.

In some embodiments of the present disclosure, in order to facilitate a storage of poured popcorn: a discharge groove is provided on the electromagnetic base, and a collection filter hopper configured to collect the popcorn is embedded at an upper of the discharge groove; a slag collection hopper extending into the discharge groove is inserted on the electromagnetic base. By using a filtering function of the collection filter, it is possible to effectively remove broken residue from popcorn, ensuring that collected popcorn is of high quality.

In some embodiments of the present disclosure, a microcrystalline plate is provided on the induction cooker. The microcrystalline plate, as a high-performance ceramic material, not only has excellent insulation performance, but also provides effective protection for electromagnetic coils inside the induction cooker, thereby ensuring a stable operation and long-term service life of the entire equipment.

The electromagnetic popcorn machine in this application heats the pot body by generating electromagnetic waves through an electromagnetic coil. The popcorn machine (induction cooker) using electromagnetic heating technology has a high thermal energy conversion rate and fast heating speed. It can reach 180° C. within 1 minute, thereby improving a puffing speed, renders the popcorn particles larger, and have a better taste. The pot body adopts a spherical design, which, due to gravity effect, keeps the corn in an effective heating area at a center of the pot body during a puffing process, thereby improving the puffing rate.

Electromagnetic heating technology is safer. Once the electromagnetic coil generates electromagnetic heating for the pot body, once the power is cut off, the electromagnetic coil will immediately stop generating electromagnetic radiation, thereby stopping heating. The coil itself does not have residual temperature, and the pot body, due to its thin wall, will quickly decrease in temperature, thereby avoiding burns to personnel and greatly shortening the time to clean the pot body after stopping heating, thereby improving the efficiency.

Due to a spherical design of the pot body, all the popcorn and seasoning sugar will be constantly stirred in the pot body before flipping (pouring the popcorn out of the pot body), which can make the seasoning sugar more evenly wrapped and enhance the taste and flavor of the popcorn.

Spherical induction cooker is more convenient to clean. The cleaning of the induction cooker only requires adding a small amount of water, turning on a stirring structure, and heating for one minute to complete an internal cleaning of the pot body. Because after heating, water evaporates to the pot wall to form water droplets, which will flow along the spherical pot wall to the bottom of the pot body, thereby achieving the effect of automatic cleaning. Due to the fast heating of the electromagnetic technology, the entire cleaning process is greatly shortened.

The present disclosure enables popcorn to be heated more evenly through a horizontal stirring, thereby avoiding problems of local overheating or insufficient overheating that may occur with traditional vertical stirring. By combining the fixed sleeves with the plurality of stirring plates to form an impeller shaped stirring blade, the popcorn and additives in the pot body can be evenly stirred, which can evenly heat the popcorn in the pot and mix it more thoroughly with the additives, thereby ensuring that each popcorn can be coated with uniform additives. Uniform heating and mixing of additives render the popcorn crispier and more flavorful. The stirring structure can accelerate the removal of popcorn from the spherical pot body when pouring it out, replacing the traditional way of using a handheld scraper to scrape the popcorn out of the spherical pot body.

The stirring plates of the present disclosure are arc-shaped plates, and the design of the arc-shaped stirring plates can produce a gentle pushing effect on the popcorn on a stirring path during a rotation of the stirring plates, rather than traditional direct impact or compression. This gentle pushing effect not only effectively reduces the mutual squeezing between popcorn, but also lowers the breakage rate of popcorn, thereby improving the overall quality of popcorn. Besides that, the arc-shaped stirring plates can better adapt to the internal space of the spherical pot body, rendering stirring more uniform and efficient. During the mixing process, popcorn can be evenly flipped with the rotations of the stirring plates, therefore ensuring that each popcorn is evenly exposed to heat and thoroughly mixed with additives.

In the present disclosure, the scraper is close contact with the inner wall of the spherical pot body. During the mixing process, the first scraper can not only ensure between the stirring plates to connect with the inner wall of the pot body, but also effectively scrape off the additives adhered to the pot body, thereby improving the mixing effect of the additives and popcorn. The first scraper can scrape off the additives adhered to the pot body, thereby avoiding a waste of additives and optimizing their distribution in the pot body, so that every popcorn can be evenly coated with additives. The design of the telescopic plate, the limit groove, and the limit plate enables the stirring structure to better adapt to spherical pot bodies with different curvatures, improving the versatility and adaptability of the equipment.

The first scraper in the present disclosure is L-shaped, and the L-shaped first scraper design fully utilizes the kinetic energy generated by the stirring plates during rotation. When the stirring plates are rotated, the L-end of the first scraper will slide along the bottom of the pot, and due to its special shape and orientation, it can effectively flip the popcorn and additives located at the bottom of the spherical pot upwards. This flipping effect not only increases the chance of mixing popcorn with additives, but also enables popcorn to be heated more evenly, thereby improving the overall quality.

The present disclosure further reduces stirring dead corners by implementing the revolution of the stirring structure, allowing popcorn and additives to mix more thoroughly and improving overall quality. This design enables the equipment to have stronger adaptability when processing different types of popcorn and can meet more diverse needs. The driven gears are arranged in a circular array and engage with the transmission gear, ensuring the stability and uniformity of power transmission and enhancing the overall stability of the equipment.

The present disclosure ensures sufficient mixing and blending of popcorn and additives between two fixed sleeves by adding the third rotation rod, the second scraper, and the stirring blade, thereby improving the overall quality. The second scraper can scrape off the additives adhered to the inner wall of the pot body and more effectively disperse them into the popcorn, thereby improving the utilization rate of the additives. The addition of the stirring blade renders the stirring structure more flexible and efficient, thereby enabling faster stirring of popcorn and additives, and improving the stirring efficiency.

### BRIEF DESCRIPTION OF DRAWINGS

FIG. 1 is a first schematic structural diagram of an electromagnetic heating popcorn machine with a spherical pot body.

FIG. 2 is a second schematic structural diagram of the electromagnetic heating popcorn machine with a spherical pot body.

FIG. 3 is a schematic diagram of a stirring structure and a driving structure.

FIG. 4 is an enlarged schematic structural diagram at point A in FIG. 3.

FIG. 5 is a schematic diagram of an internal structure of a stirring plate.

FIG. 6 is a schematic diagram of a tilted state of a spherical pot body.

Numeral reference: 1—electromagnetic base; 11—discharge groove; 2—spherical pot body; 3—induction cooker; 31—microcrystalline plate; 4—stirring structure; 41—bracket; 411—vertical groove; 42—T-shaped sleeve; 43—first rotation rod; 44—fixed sleeve; 45—stirring plate; 451—telescopic plate; 452—first scraper; 453—limit groove; 454—limit plate; 455—spring; 46—driving component; 461—first bevel gear; 462—second rotation rod; 463—second bevel gear; 464—driving motor; 5—driving structure; 51—transmission gear; 52—driven gear; 53—internal gear ring; 6—third rotation rod; 61—second scraper; 62—stirring blade; 7—protective cover; 71—ventilation hole; 72—fixed rod; 73—electric push rod; 8—support rod; 81—bearing seat; 82—hydraulic cylinder; 9—collection filter hopper; 91—slag collection hopper.

### DESCRIPTION OF EMBODIMENTS

The following will provide a clear and complete description of the technical solution in the embodiments of the present disclosure, combined with the accompanying drawings. Obviously, the described embodiments are only a part of the embodiments of the present disclosure, not all of them. Electromagnetic based on the embodiments in the present disclosure, all other embodiments obtained by those skilled in the art without creative work are within the protection scope of the present disclosure.

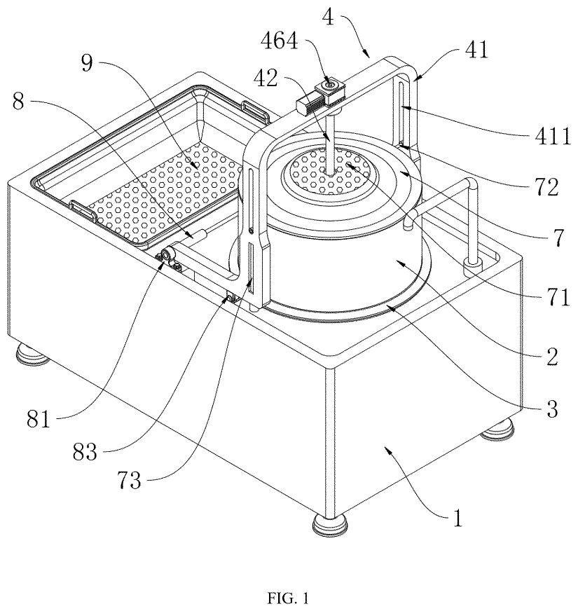

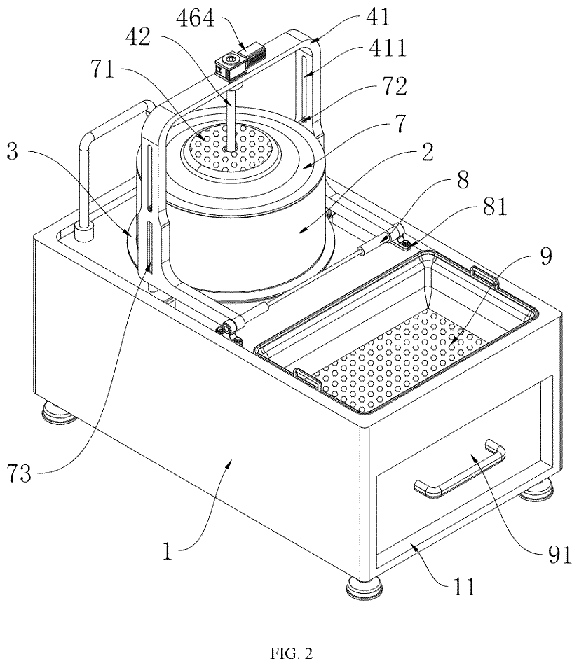

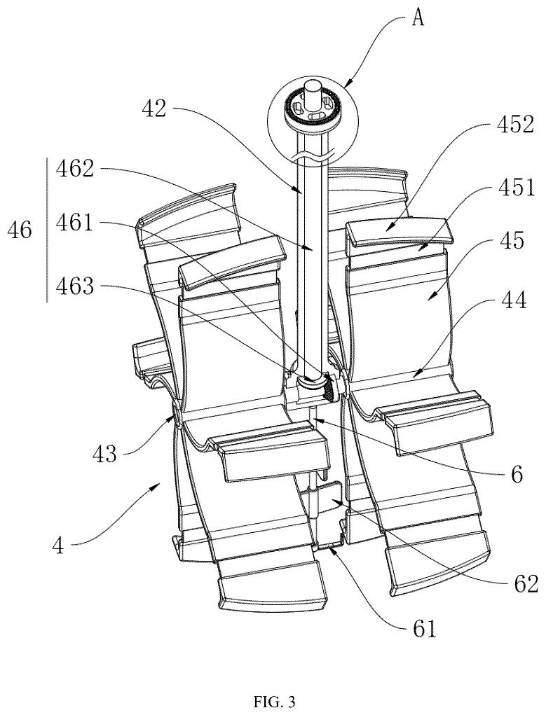

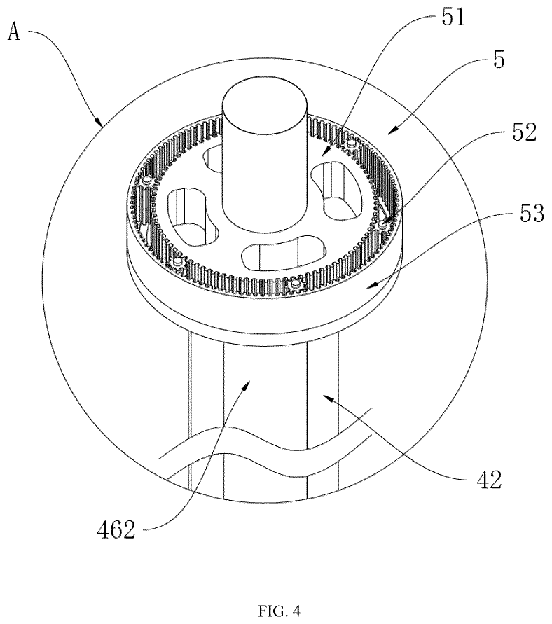

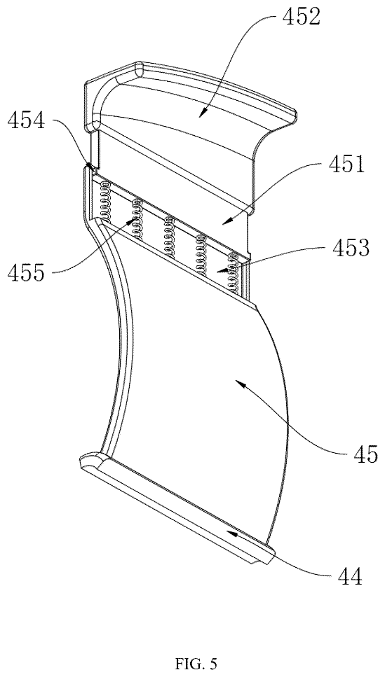

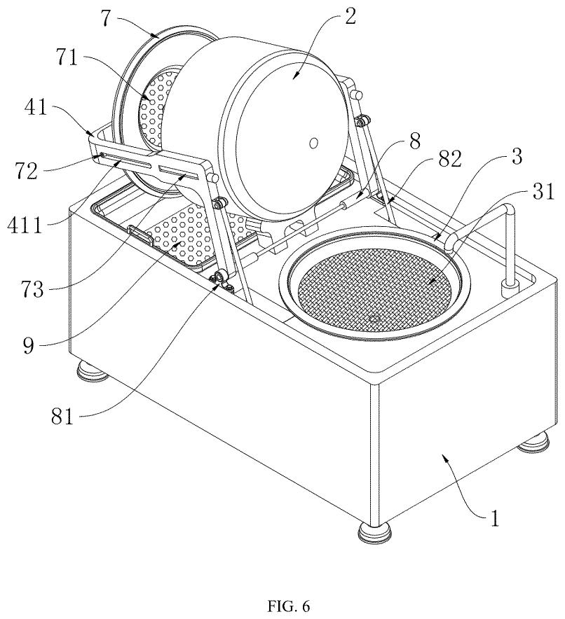

This embodiment provides an electromagnetic heating popcorn machine with a spherical pot body, as shown in FIGS. 1-6. The popcorn machine includes a electromagnetic base 1, a spherical pot body 2 movably provided on the electromagnetic base 1, an induction cooker 3 fixedly installed on the electromagnetic base 1 and adapted to a bottom of the spherical pot body 2, and a stirring structure 4 configured to stir popcorn inside the spherical pot body 2; a microcrystalline plate 31 is provided on the induction cooker 3. The microcrystalline plate 31, as a high-performance ceramic material, not only has excellent insulation performance, but also provides effective protection for electromagnetic coils inside the induction cooker 3, ensuring a stable operation and long-term service life of the entire equipment. The thermal insulation effect of the microcrystalline plate 31 cannot be ignored. During the operation of the induction cooker 3, the electromagnetic coils generate a large amount of heat. If the heat cannot be effectively isolated, it will not only affect the efficiency of the induction cooker 3 but may also cause damage to surrounding components. The microcrystalline plate 31, with its excellent thermal insulation performance, can effectively isolate the heat generated by the electromagnetic coils inside, prevent the heat from spreading to the outside, and ensure the safe operation of the induction cooker 3 and surrounding components. Furthermore, the microcrystalline plate 31 also plays a crucial protective role for the electromagnetic coils. During long-term use, the electromagnetic coils may be damaged due to various factors such as vibration, friction, etc. The microcrystalline plate 31, with its hard material and excellent wear resistance, can provide a solid protective layer for the electromagnetic coils, thereby effectively resisting external factors and prolonging the service life of the electromagnetic coils.

The electromagnetic popcorn machine in this application heats the pot body by generating electromagnetic waves through an electromagnetic coil. The popcorn machine (induction cooker) using electromagnetic heating technology has a high thermal energy conversion rate and fast heating speed. It can reach 180° C. within 1 minute, thereby improving a puffing speed, renders the popcorn particles larger, and have a better taste. The pot body adopts a spherical design, which, due to gravity effect, keeps the corn in an effective heating area at a center of the pot body during a puffing process, thereby improving the puffing rate.

Electromagnetic heating technology is safer. Once the electromagnetic coil generates electromagnetic heating for the pot body, once the power is cut off, the electromagnetic coil will immediately stop generating electromagnetic radiation, thereby stopping heating. The coil itself does not have residual temperature, and the pot body, due to its thin wall, will quickly decrease in temperature, thereby avoiding burns to personnel and greatly shortening the time to clean the pot body after stopping heating, thereby improving the efficiency.

Due to a spherical design of the pot body, all the popcorn and seasoning sugar will be constantly stirred in the pot body before flipping (pouring the popcorn out of the pot body), which can make the seasoning sugar more evenly wrapped and enhance the taste and flavor of the popcorn.

Spherical induction cooker is more convenient to clean. The cleaning of the induction cooker only requires adding a small amount of water, turning on a stirring structure, and heating for one minute to complete an internal cleaning of the pot body. Because after heating, water evaporates to the pot wall to form water droplets, which will flow along the spherical pot wall to the bottom of the pot body, thereby achieving the effect of automatic cleaning. Due to the fast heating of the electromagnetic technology, the entire cleaning process is greatly shortened.

Where, the spherical pot body 2 is heated by a cooperation of the electromagnetic base 1 and the induction cooker 3. The use of electromagnetic heating can shorten the heating time for the spherical pot body 2 and improve the processing efficiency of popcorn. This electromagnetic heating technology heats the pot directly, reducing energy transfer losses and significantly improving thermal efficiency. Compared to traditional resistance heating or gas heating ways, electromagnetic heating has a higher thermal efficiency, usually reaching over 98%, thereby achieving higher energy utilization and lower energy consumption. This high-efficiency and energy-saving feature enables the electromagnetic heating pot body to significantly reduce energy consumption and lower operating costs during long-term use.

By using electromagnetic heating, the heating power can be automatically adjusted according to a set temperature, ensuring the temperature stability of popcorn during processing. Accurate temperature control can avoid the problem of unstable quality of popcorn caused by temperature fluctuations, ensuring the consistency of the product. The electromagnetic heating process does not produce harmful substances, does not pollute the environment, and conforms to the concept of green environmental protection. Compared to gas heating ways, electromagnetic heating reduces exhaust emissions and noise pollution, which is beneficial for protecting the environment and improving the working environment in the kitchen.

By using electromagnetic heating, the pot body will exhibit heating characteristics such as rapid heating, uniform heating, and temperature controllability after heating, and has advantages such as high efficiency, energy saving, environmental friendliness, high safety performance, easy cleaning and maintenance, and multifunctionality.

The stirring structure 4 includes a bracket 41 fixedly provided on the spherical pot body 2, a T-shaped sleeve 42 inserted on the bracket 41 and extending into the spherical pot body 2, a first rotation rod 43 horizontally inserted at a bottom of the T-shaped sleeve 42, fixed sleeves 44 symmetrically sleeved on two sides of the first rotation rod 43, a plurality of stirring plates 45 that are arranged in a circular array and fixedly connected to the fixed sleeves 44, and a driving component 46 configured to drive the first rotation rod 43 to rotate; a horizontal stirring way allows popcorn to be heated more evenly, thereby avoiding problems of local overheating or insufficient overheating that may occur with traditional vertical stirring. By combining the fixed sleeves 44 with the plurality of stirring plates 45 to form an impeller shaped stirring blade, the popcorn and additives in the pot body can be evenly flipped, which can evenly heat the popcorn in the pot body and mix the popcorn and additives more thoroughly, ensuring that each popcorn flower can be evenly coated with additives. Uniform heating and mixing of the additives render the popcorn crispier and more flavorful. The stirring structure 4 can accelerate a removal of popcorn from the spherical pot body 2 by pouring it out, replacing a traditional way of using a handheld scraper to scrape the popcorn out of the spherical pot body 2. The design of spherical pot body 2 render cleaning work simpler and more convenient, that is, simply adding a small amount of water and starting the stirring structure 4 to heat for one minute to complete the cleaning. When in use, the induction cooker 3 first started to heat the spherical pot body 2. Then, the first rotation rod 43 is driven to rotate by the driving component 46. The first rotation rod 43 drives the popcorn and additives inside the spherical pot body 2 to flip back and forth through the fixed sleeves 44 and the stirring plates 45. This flipping not only evenly heats the popcorn, but also thoroughly mixes it with additives. When the popcorn reaches the desired texture and taste, the induction cooker 3 is turned off and the operation of the driving component 46 is stopped. At this point, due to a stirring effect of the stirring structure 4, popcorn can be quickly removed from the spherical pot body 2 for consumers to enjoy. When cleaning, simply add a small amount of water and start the stirring structure 4 to heat for one minute, water droplets formed by water evaporation can be used to automatically clean an inside of the spherical pot body 2.

The driving component 46 includes a first bevel gear 461 fixedly provided on the first rotation rod 43, a second rotation rod 462 vertically and rotatably inserted into the T-shaped sleeve 42, a second bevel gear 463 fixedly sleeved on a bottom of the second rotation rod 462 and engaged with the first bevel gear 461, and a driving motor 464 fixedly provided on the bracket 41. An output end of the driving motor 464 is fixedly connected to an upper of the second rotation rod 462. The design of bevel gear transmission renders power transmission more efficient and stable, ensuring that the stirring structure 4 can maintain stable mixing effect even during high-speed operation. When the popcorn machine starts working, the induction cooker 3 heats the spherical pot body 2. At the same time, the driving motor 464 starts and drives the second rotation rod 462 to rotate. As the second rotation rod 462 is rotated, the second bevel gear 463 begins to engage with the first bevel gear 461 and transmit power. The first rotation rod 43, driven by the first bevel gear 461, uniformly mixes the popcorn and additives inside the pot body through the fixed sleeves 44 and the stirring plates 45. During a mixing process, the popcorn is heated evenly, and the additives can be fully wrapped around the popcorn. When the popcorn reaches the desired taste and flavor, the induction cooker 3 and driving motor 464 are turned off, the popcorn is poured out of the spherical pot body 2 and enjoy it.

In order to reduce a risk of popcorn being crushed by the stirring plates 45: the stirring plates 45 are arc-shaped plates, and curvatures are arranged along a rotation direction of the first rotation rod 43. The arc-shaped stirring plates 45 are designed, and during the rotations of the stirring plates 45, its curvature can produce a gentle pushing effect on the popcorn on a stirring path, rather than traditional direct impact or compression. This gentle pushing effect not only effectively reduces a mutual squeezing between popcorn, but also lowers a breakage rate of popcorn, thereby improving the overall quality of popcorn. In addition, the arc-shaped stirring plates 45 can better adapt to an internal space of the spherical pot body 2, rendering stirring more uniform and efficient. During the mixing process, the popcorn can be evenly flipped with the rotations of the stirring plates 45, ensuring that each popcorn is evenly exposed to heat and thoroughly mixed with additives.

In order to facilitate one end of each of the stirring plates 45 to always be in contact with the inner wall of the pot body, a telescopic plate 451 is slidably inserted into one ends of the stirring plates 45 away from the fixed sleeves 44. A first scraper 452 that abuts against an inner wall of the spherical pot body 2 is fixedly connected to one end of the telescopic plate 451 away from the stirring plates 45. A limit groove 453 is provided inside the stirring plates 45, and a limit plate 454 that is fixedly connected to the telescopic plate 451 is provided inside the limit groove 453. A spring 455 is provided at one end of the limit groove 453 and one end of the limit plate 454 that are away from the telescopic plate 451. A close contact between the scraper and the inner wall of the spherical pot body 2, during a mixing process, the first scraper 452 not only ensures the stirring plates 45 to contact with the inner wall of the pot body, but also effectively scrapes off the additives adhered to the pot body, thereby improving the mixing effect of the additives and popcorn. The first scraper 452 can scrape off the additives adhered to the pot body, avoiding a waste of additives and optimizing their distribution in the pot body, so that each popcorn can be evenly coated with additives. The design of the telescopic plate 451, the limit groove 453, and the limit plate 454 enables the stirring structure 4 to better adapt to spherical pot bodies 2 with different curvatures, thereby improving the versatility and adaptability of the equipment. During the mixing process, as the stirring plates 45 are rotated, the telescopic plate 451 and the first scraper 452 are moved accordingly. Due to an elastic force of the spring 455, the telescopic plate 451 can always maintain a certain tension, rendering the first scraper 452 tightly adhere to the inner wall of the spherical pot body 2. When the stirring plates 45 are rotated to different positions of the spherical pot body 2, the telescopic plate 451 will be adaptively adjusted according to the curvature of the pot body, ensuring that the first scraper 452 always contacts the inner wall of the pot body. At the same time, the first scraper 452 will scrape off the additives adhered to the pot body during its movement and mixing them thoroughly with the popcorn. This design not only improves the mixing effect, but also optimizes the distribution of additives, bringing consumers a better popcorn eating experience.

In order to facilitate the stirring plates 45 to drive the popcorn and additives located inside the spherical pot body 2 to flip upwards during a rotation process, the first scraper 452 is a L-shaped plate, a L-end of the first scraper 452 is arranged along a rotation direction of the first rotation rod 43. The L-shaped first scraper 452 design fully utilizes the kinetic energy generated by the stirring plates 45 during rotation. When the stirring plates 45 are rotated, the L-end of the first scraper 452 will slide along the bottom of the pot body, and due to its special shape and orientation, it can effectively flip the popcorn and additives located at the bottom of the spherical pot body 2 upwards. This flipping effect not only increases the chance of mixing popcorn with additives, but also enables popcorn to be heated more evenly, thereby improving the overall quality. Besides that, the L-shaped first scraper 452 can effectively disperse the additives adhered to the pot body into the popcorn when scraping them off, thereby avoiding local accumulation of additives and further improving the mixing effect.

In order to facilitate a rotation of the stirring structure 4 around the second rotation rod 462 in a circumferential direction, the driving structure 5 on the bracket 41 is used to drive the T-shaped sleeve 42 to rotate in the circumferential direction. The driving structure 5 includes a transmission gear 51 fixedly provided on the second rotation rod 462, a plurality of driven gears 52 that are arranged in a circular array, engaged with the transmission gear 51 and rotatably connected to the bracket 41, and an internal gear ring 53 that engages with the driven gears 52 and is fixedly connected to an upper of the T-shaped sleeve 42. By implementing a revolution of the stirring structure 4, dead corners of stirring are further reduced, allowing popcorn and additives to mix more thoroughly and improving the overall quality. This design enables the equipment to have stronger adaptability when processing different types of popcorn, and can meet more diverse needs. The circular array of driven gears 52 engaged with the transmission gear 51, can ensure the stability and uniformity of power transmission and enhance the overall stability of the equipment. Driven by the driving motor 464, the second rotation rod 462 begins to rotate and drives the transmission gear 51 fixed on it to rotate. Due to the circular array of the driven gears 52 engaging with the transmission gear 51, the driven gears 52 will also rotate with the rotation of the transmission gear 51. Due to the engagement of the internal gear ring 53 on the driven gears 52 and its fixed connection with the upper of the T-shaped sleeve 42, the T-shaped sleeve 42 will be rotated around the first rotation rod 43 (i.e. an axis of the pot body) as the driven gears 52 are rotated. In this way, the stirring structure 4 achieves the revolution around the axis of the pot body, thereby further improving the mixing effect of popcorn and additives.

In order to facilitate the mixing of popcorn and additives located between two fixed sleeves 44 at the bottom of the pot body, a third rotation rod 6 is fixedly connected to a bottom of the T-shaped sleeve 42. A bottom of the third rotation rod 6 is fixedly sleeved with a second scraper 61 that abuts against the inner wall of the spherical pot body 2, and a stirring blade 62 is fixedly sleeved on the third rotation rod 6. By adding the third rotation rod 6, the second scraper 61, and the stirring blade 62, it is ensured that the popcorn and additives located between the two fixed sleeves 44 can be thoroughly stirred and mixed, thereby improving the overall quality. The second scraper 61 can scrape off the additives adhered to the inner wall of the pot body and more effectively disperse them into the popcorn, thereby improving the utilization rate of the additives. The addition of the stirring blade 62 renders the stirring structure 4 more flexible and efficient, enabling faster stirring of popcorn and additives, and improving stirring efficiency. During the mixing process, as the T-shaped sleeve 42 is rotated, the third rotation rod 6, the second scraper 61, and the stirring blade 62 are also rotated synchronously. The second scraper 61 will tightly contact the inner wall of the spherical pot body 2 during the rotation process, scrape off the additives adhered to it, and disperse them into the popcorn. At the same time, the stirring blade 62 will stir the popcorn and additives located between the two fixed sleeves 44 to ensure that they can be thoroughly mixed. This design not only allows popcorn to be heated and coated with additives more evenly but also improves the utilization and mixing effect of additives.

In order to prevent popcorn from being removed from the spherical pot body 2 during processing, a protective cover 7 that abuts against an upper of the spherical pot body 2 is sleeved on the T-shaped sleeve 42, and a plurality of ventilation hole 71 are provided on the protective cover 7. In order to facilitate the addition of popcorn and additives into the spherical pot body 2, two ends of the protective cover 7 are symmetrically and fixedly connected with fixed rods 72. The bracket 41 is provided with vertical grooves 411 for the fixed rods 72 to move up and down, and an electric push rod 73 is fixedly provided inside the bracket 41. An output end of the electric push rod 73 is fixedly connected to bottoms of the fixed rods 72. The design of the protective cover 7 effectively prevents splashing during popcorn processing, ensuring the safety of an operator and the cleanliness of the environment. A linkage design between the electric push rod 73, the fixed rods 72, and the vertical grooves 411 renders the up and down movement of the protective cover 7 easy and convenient, thereby greatly improving the automation and efficiency of the operation. The setting of ventilation holes 71 ensures a smooth discharge of gas from the pot body and avoids the risk of splashing, thereby creating a safer and more efficient environment for popcorn processing. Before the popcorn processing begins, the electric push rod 73 pushes the fixed rods 72 and the connected protective cover 7 upward through its output end, the protective cover 7 is caused to detach from an open end of the spherical pot body 2, thereby exposing enough space for the operator to add popcorn and additives to the pot body. After the addition is completed, the electric push rod 73 drives the protective cover 7 to slowly move down until it tightly fits the upper of the spherical pot body 2, thereby forming an effective protective barrier. During this processing, the gas generated in the pot body is smoothly discharged through the ventilation holes 71 on the protective cover 7, while the popcorn is firmly confined in the pot body to avoid the risk of splashing. After processing, the electric push rod 73 drives the protective cover 7 to move up again, and the operator can easily remove the popcorn from the spherical pot body 2.

In order to facilitate a pouring of popcorn from the pot, a support rod 8 is fixedly inserted on the bracket 41, two ends of the support rod 8 are sleeved with bearing seats 81 fixedly connected to the electromagnetic base 1. A hydraulic cylinder 82 is rotatably provided on the electromagnetic base 1, and an output end of the hydraulic cylinder 82 is movably connected to the bracket 41. The introduction of the hydraulic cylinder 82 renders the pouring of spherical pot body 2 easy and efficient, and the operator can pour out popcorn without any effort, greatly improving the convenience of operation. By combining the support rod 8, the bearing seats 81, and the hydraulic cylinder 82, not only is the convenient tilting of the spherical pot body 2 achieved, but also the stability and safety of the entire equipment during the tilting process are ensured. The convenient pouring mechanism enables the operator to easily complete the processing and pouring of popcorn, thereby enhancing the overall user experience. After the popcorn processing is completed, the operator will first activate the hydraulic cylinder 82. As the output end of the hydraulic cylinder 82 starts working, it will push a movable end of the bracket 41 to rotate counterclockwise around bearing seats 81. This rotation process will gradually tilt the spherical pot body 2, which was originally in a vertical state, until it reaches an angle that is convenient for pouring out popcorn. At this point, the operator can easily pour the popcorn out of the spherical pot body 2, thereby completing the entire processing process. It is worth noting that the combination design of the support rod 8 and the bearing seats 81 ensures stable support and smooth rotation of the bracket 41 and the spherical pot body 2 throughout the entire tilting process, while a precise control of the hydraulic cylinder 82 renders the tilting process smoother and more efficient.

In order to facilitate a storage of poured popcorn, the electromagnetic base 1 is provided with a discharge groove 11, and an upper of the discharge groove 11 is provided with a collection filter hopper 9 for collecting popcorn. The electromagnetic base 1 is further provided with a slag collection hopper 91 that extends into the discharge groove 11. By collecting a filtering function of collection filter hopper 9, it is possible to effectively remove broken residue from popcorn, ensuring that collected popcorn is of high quality. The combination design of the discharge groove 11 and the collection filter hopper 9 renders the collection process of popcorn smoother and more efficient, thereby avoiding losses caused by improper collection. The convenient collection and filtering mechanism enables the operator to easily complete the collection and subsequent processing of popcorn, thereby enhancing the overall user experience. After the popcorn processing is completed, the operator will activate the hydraulic cylinder 82 to rotate the spherical pot body 2 from a vertical state to an inclined state, and the popcorn will be poured out from the pot body accordingly. At this time, the popcorn will fall into the collection filter hopper 9 along a guide of the discharge groove 11. In the collection filter hopper, popcorn is filtered through a filter screen, effectively removing impurities such as broken residue, while clean popcorn continues to fall into the collection container below. At the same time, the filtered residue will fall into the slag collection hopper 91, thereby facilitating subsequent cleaning work. The entire collection and filtering process is efficient and smooth, without the need for excessive intervention from the operator, therefor greatly improving the automation level and work efficiency of the equipment.

The above description is only preferred implementation modes of the present disclosure, but the protection scope of the present disclosure is not limited to this. Any skilled person familiar with the technical field should be included in the protection scope of the present disclosure by equivalent substitution or modification electromagnetic based on the technical solution and concept disclosed in the present disclosure.

What is claimed is:

1. An electromagnetic heating popcorn machine with a spherical pot body, comprising a electromagnetic base, a spherical pot body provided on the electromagnetic base, an induction cooker fixedly provided on the electromagnetic base and adapted to a bottom of the spherical pot body, and a stirring structure configured to stir popcorn inside the spherical pot body;
wherein the spherical pot body is heated by a cooperation of the electromagnetic base and the induction cooker; the stirring structure comprises a bracket fixedly provided on the spherical pot body, a T-shaped sleeve inserted on the bracket and extending into the spherical pot body, a first rotation rod inserted horizontally at a bottom of the T-shaped sleeve, fixed sleeves symmetrically fixed on two sides of the first rotation rod, a plurality of stirring plates that are arranged in a circular array and fixedly connected to the fixed sleeves, and a driving component configured to drive the first rotation rod to rotate;
the driving component comprises a first bevel gear fixedly sleeved on the first rotation rod, a second rotation rod vertically and rotatably inserted into the T-shaped sleeve, a second bevel gear fixedly sleeved on a bottom of the second rotation rod and engaged with the first bevel gear, and a driving motor fixedly provided on the bracket;
an output end of the driving motor is fixedly connected to an upper of the second rotation rod.

2. The electromagnetic heating popcorn machine with a spherical pot body according to claim 1, wherein the stirring plates are arc-shaped plates, curvatures of the stirring plates are arranged along a rotation direction of the first rotation rod.

3. The electromagnetic heating popcorn machine with a spherical pot body according to claim 1, wherein one end of each of the stirring plates far away from the fixed sleeves is slidably inserted with a telescopic plate;
one end of the telescopic plate far away from the stirring plates is fixedly connected with a first scraper that abuts against an inner wall of the spherical pot body;
a limit groove is provided inside the stirring plates, and a limit plate fixedly connected to the telescopic plate is provided inside the limit groove;
one end of the limit groove and one end of the telescopic plate that are away from the telescopic plate are provided with springs.

4. The electromagnetic heating popcorn machine with a spherical pot body according to claim 3, wherein the first scraper is a L-shaped plate, a L-end of the first scraper is arranged along the rotation direction of the first rotation rod.

5. The electromagnetic heating popcorn machine with a spherical pot body according to claim 1, wherein a driving structure configured to drive the T-shaped sleeve to rotate in a circumferential direction is provided on the bracket;
the driving structure comprises a transmission gear fixedly sleeved on the second rotation rod, a plurality of driven gears that are arranged in a circular array, engaged on the transmission gear and rotatably connected to the bracket; and an internal gear ring sleeved on the driven gears and fixedly connected to an upper of the T-shaped sleeve.

6. The electromagnetic heating popcorn machine with a spherical pot body according to claim 1, wherein a bottom of the T-shaped sleeve is fixedly connected to a third rotation rod, and a bottom of the third rotation rod is fixedly sleeved with a second scraper that abuts against an inner wall of the spherical pot body;
a stirring blade is fixedly sleeved on the third rotation rod.

7. The electromagnetic heating popcorn machine with a spherical pot body according to claim 1, wherein the T-shaped sleeve is sleeved with a protective cover that abuts against an upper of the spherical pot body;
the protective cover is provided with a plurality of ventilation holes;
two ends of the protective cover are symmetrically and fixedly connected to fixed rods;
the bracket is provided with vertical grooves for the fixed rods to move up and down;
an electric push rod is fixedly provided inside the bracket;
an output end of the electric push rod is fixedly connected to bottoms of the fixed rods.

8. The electromagnetic heating popcorn machine with a spherical pot body according to claim 1, wherein a support rod is fixedly inserted on the bracket;
two ends of the support rod are sleeved with bearing seats that are fixedly connected to the electromagnetic base;
a hydraulic cylinder is rotatably provided on the electromagnetic base;
an output end of the hydraulic cylinder is connected to the bracket.

9. The electromagnetic heating popcorn machine with a spherical pot body according to claim 1, wherein a discharge groove is provided on the electromagnetic base, and a collection filter hopper configured to collect the popcorn is embedded at an upper of the discharge groove;
a slag collection hopper extending into the discharge groove is inserted on the electromagnetic base.

10. The electromagnetic heating popcorn machine with a spherical pot body according to claim 1, wherein a microcrystalline plate is provided on the induction cooker.
